(19) United States
(12) Patent Application Publication
(10) Pub. No.: US 2026/0276018 A1
(43) Pub. Date: Sep. 17, 2026

(54) Breakstem Blind Rivet and Method for Producing an Electrically Conductive Riveted Connection

(71) Applicant: Bayerische Motoren Werke Aktiengesellschaft, Muenchen (DE)

(72) Inventors: Johann ROETZER, Notzing (DE); Robert WEINMANN, Rammingen (DE)

(21) Appl. No.: 18/870,722

(22) PCT Filed: Oct. 16, 2023
(86) PCT No.: PCT/EP2023/078642

§ 371 Date: Dec. 2, 2024

(30) Foreign Application Priority Data
Oct. 20, 2022 (DE) 10 2022 127 719.4

(51) Int. Cl. F16B 19/10; F16B 5/04

(52) U.S. Cl. CPC F16B 19/1054; F16B 5/04; F16B 2200/93

(57) ABSTRACT

A breakstem blind rivet for the electrically conductive riveting of a first component to a second component, includes a sleeve having a head and a shank, and a tension mandrel having a mandrel head. The shank and/or the mandrel head have at least one scraping element, which is arranged on the outer circumferential surface of the shank or mandrel head and is intended, during insertion of the sleeve into a rivet hole provided for this purpose, to scrape along the wall of the hole and to remove paint buildup or contaminants. A method for producing an electrically conductive riveted connection utilizes such a breakstem blind rivet.

### BACKGROUND AND SUMMARY

The invention relates to a breakstem blind rivet. Furthermore, the invention relates to a method for producing an electrically conductive rivet connection between two components by means of a breakstem blind rivet.

Breakstem blind rivets and methods for producing a rivet connection by means of a breakstem blind rivet are known from the prior art, for which by way of example reference may be made to DE 201 02 898 U1 and EP 3 111 097 B1.

A breakstem blind rivet (tension mandrel rivet) has a sleeve (rivet sleeve) having a shank (sleeve shank) and a head (sleeve head) and a tension mandrel (rivet mandrel) which extends through the sleeve, that is to say, the shank and the head. The tension mandrel is configured with a mandrel head (setting head) and typically also with at least one desired breaking location. In order to describe the invention, the terms set out above or alternatively the alternative terms given in brackets are used below, wherein in the prior art other names are also sometimes conventional.

Riveting, that is to say, the production of a riveting or a rivet connection by means of a breakstem blind rivet, involves at least two partial procedures: firstly, the introduction or setting of the sleeve in a rivet opening provided for this purpose or rivet (hole) bore and, secondly, the expansion of the sleeve (in the narrower sense also referred to as the setting or setting operation) by pulling the tension mandrel or by applying an axial tensile force to the tension mandrel with simultaneous support via the head, whereby the sleeve is plastically deformed in known manner.

There are known from the prior art specific embodiments of breakstem blind rivets which are suitable for producing an electrical connection with good contacting being brought about.

The closest publication DE36 12 501 A1 describes such a breakstem blind rivet, the shank of which is provided with longitudinally directed grooves in a state distributed over the circumference, wherein the grooves extend as an axial corrugation substantially over the length of the shank located inside the (rivet) hole. As a result of this corrugation, it is possible for the ribs which have remained between the grooves when the (tension) mandrel is pulled under particularly high pressure to bear against the wall of the hole through which the rivet or the shank thereof extends. Any impurities or where applicable paint coatings are thereby broken up so that good contacting is produced between the component and the ribs.

In addition, reference may also be made to the breakstem blind rivet described in DE36 12 478 A1 which also enables a particularly good electrical contacting.

Based on the above-cited closest prior art, an object of the invention is to provide an improved breakstem blind rivet and a method which can be carried out therewith for producing an electrically conductive rivet connection which are also particularly suitable for painted components and which reliably enable an electrical contacting with low resistance.

The object is achieved with a breakstem blind rivet and a method in accordance with the independent claims(s). The invention also extends to a preferred use of the breakstem blind rivet according to the invention. Additional features will be appreciated in a similar manner for all the aspects of subject-matter from the dependent patent claims, the additional invention description and the drawings, wherein this also expressly includes features which are described by way of example and optionally.

The invention is particularly suitable for the earth (ground) connection of a vehicle component, in particular an electric vehicle component, to an already painted body component or to the already painted vehicle body, as explained in greater detail below.

The breakstem blind rivet according to the invention is provided for electrically conductive riveting of a first component, whereby at least one first component is intended to be understood, to a second component, whereby at least one second component is intended to be understood. The breakstem blind rivet according to the invention has a sleeve which is configured with a head and a shank and a tension mandrel which is configured with a mandrel head. The breakstem blind rivet according to the invention is characterized in that the shank (the sleeve) and/or the mandrel head (of the tension mandrel) has/have at least one scraping element which is arranged on the outer circumferential face thereof and which is provided, when the sleeve is introduced into a rivet hole provided for this purpose, to scrape along the hole wall and to remove or at least break up any paint deposits and/or impurities on the hole wall. Preferably, the at least one scraping element is arranged only on the shank or only on the mandrel head.

An electrically conductive riveting or rivet connection is intended to be understood to be a positive-locking and permanent joint connection provided by means of the breakstem blind rivet between the first component and the second component which is configured in such a manner that there is also an electrically conductive connection at the connection or joining location between the first component and the second component. The electrically conductive connection is brought about at least indirectly via the set or joined breakstem blind rivet even when at the connection location between the first component and the second component a direct conductive connection is not possible (for example, as a result of painting, a protective layer or the like). The breakstem blind rivet consequently acts virtually as a joining and electrical contact element.

The breakstem blind rivet according to the invention has at least one scraping element which is arranged on the outer circumferential face of the shank (sleeve shank) and/or at least one scraping element which is arranged on the outer circumferential face of the mandrel head. The outer circumferential face is intended to be understood to be the radial or lateral covering face of the shank or mandrel head. The scraping element may also extend from the relevant covering face into the axial end face of the shank or mandrel head. The at least one scraping element is configured already when the sleeve is inserted or pushed into the rivet hole which is provided for the purpose to scrape along the hole wall, that is to say, along the inner circumferential face of the rivet hole which extends through the first component and the second component and in this instance (as a result of a scraping effect: see below) to completely or partially remove or at least to break up any paint deposits, impurities or the like which are located inside the rivet hole in the first component and/or in the second component. When subsequently expanding the sleeve, a good, that is to say, low-resistance electrically conductive contact can thus be formed between the sleeve and at least one of the components.

The scraping effect is produced in particular as a result of a sharp-edged configuration of the at least one scraping element and/or by means of a high friction coefficient between the scraping element and the hole wall. As a result of a sharp-edged, in particular blade-like, configuration of the at least one scraping element, where applicable a combined cutting/scraping effect can also be brought about.

Preferably, the at least one scraping element is configured with respect to the rivet hole in such a manner that when introduced or inserted only any paint deposits, impurities or the like are removed or at least broken up without significant removal of base material on the components. Ideally, the hole wall or the rivet hole after the breakstem blind rivet according to the invention has been introduced is bare, in particular metallically bare.

In contrast to the breakstem blind rivet which is described in DE 36 12 501 A1 and which breaks up impurities or paint coatings in the rivet hole only during expansion, the breakstem blind rivet according to the invention is configured in such a manner that paint coatings or paint deposits, impurities and the like which prevent contact or impair contact are scraped off, removed or broken up already during introduction or insertion into the rivet hole. Particles which are released in this case can thus fall out of the rivet hole or are pushed through and therefore subsequently cannot lead to any impairment.

The breakstem blind rivet according to the invention is particularly suitable for producing an electrically conductive rivet connection between two components, wherein at least one of the components has been painted after the introduction of the rivet hole or opening so that a paint deposit is located within the rivet hole. The breakstem blind rivet according to the invention can in this instance be introduced or inserted into the rivet hole directly, that is to say, without separate pre-treatment. This is carried out in particular in an automated or partially automated manner, as explained in greater detail below.

The sleeve and/or the tension mandrel of the breakstem blind rivet according to the invention is/are preferably formed from metal, particularly from steel, preferably with an integral configuration. The at least one scraping element may be integrated in the sleeve or shank wall, that is to say, configured integrally with the sleeve or the shank. The sleeve or the shank may be cold extruded, wherein the at least one scraping element may also be pressed or subsequently stamped so that the scraping element as a result of strain hardening is formed to be particularly hard. The sleeve, including the at least one scraping element, may further also be produced in another manner, in particular as a result of other shaping, for example, compressing, cutting and/or machining production operations. The same applies in a similar manner to the mandrel head, that is to say, the at least one scraping element may be integrated in the mandrel head, that is to say, configured integrally with the mandrel head. In principle, however, a scraping element may also be produced separately and be secured in an appropriate manner to the sleeve or the shank or mandrel head (non-integral configuration).

The scraping element may be in the form of a rib which protrudes radially or protrudes in a radial direction. A rib is in particular a narrow, ridge-like projection. The rib may extend in a linear manner in an axial direction, in a circumferential direction or also be configured in a helical manner. In the direction of the head (sleeve head), the rib may be configured in a conical manner, that is to say, with a successively increasing rib height (in a radial direction) and/or rib width (in a circumferential direction). The rib may extend continuously, in particular with a conical configuration, over the entire axial length of the shank (that is to say, from the front axial end, that is to say, the end facing away from the head, or shank end up to the head) or mandrel head or only over a part-length (see below). Preferably, a plurality of ribs which act as scraping elements are provided, for example, three or four ribs, which are in particular arranged in a state distributed in a uniform manner on the outer circumferential face of the shank or mandrel head. The ribs may be configured identically or also differently.

The axial direction is predetermined or defined by the longitudinal axis of the sleeve or the tension mandrel. The radial direction extends perpendicularly thereto. The circumferential direction can be defined with respect to the outer circumferential face or lateral covering face of the shank or mandrel head as a direction which follows the circumferential curvature.

The scraping element may also be in the form of a ring segment which is circumferential, that is to say, extends in the circumferential direction, or at least a ring segment which extends partially (in the circumferential direction). A ring or ring segment is in particular a projection which extends in an annular manner in the circumferential direction and which is configured to be thicker or wider in comparison with a rib (see above). The ring or the ring segment may in particular be in the form of a radial thickening or radial oversizing. Preferably, the ring or the ring segment extends in an axial direction over only a partial length (see below) of the shank or mandrel head. Preferably, the outer face of the ring or the ring segment has a nature which promotes the scraping effect, for example, a surface structuring. Such a surface structuring is in particular a rasp-like surface structure, such as, for example, a sharp-edged corrugation or knurling.

The scraping element may also be in the form of a resilient curved member or spring clip. Such a resilient curved member protrudes in a radial direction from the shank or mandrel head and can, when the sleeve is introduced or inserted into the rivet hole, become deformed in a radial direction and in particular bear on the shank. Inter alia, a tolerance compensation is thereby enabled (punched rivet holes may have comparatively large hole tolerances of several tenths of a millimeter). The resilient curved member may be in the form of a strip element or ring element. The outer face of such a resilient curved member may have a nature, for example, a surface structuring (see above) which promotes the scraping effect. Preferably, there are provided a plurality of resilient curved members which act as scraping elements and which are preferably in the form of strip elements and are in particular arranged in a state distributed in a uniform manner on the outer circumferential face of the shank or mandrel head. The resilient curved members may be configured identically or also differently.

The possible embodiments described above of a scraping element can also expressly be combined with each other.

Preferably, the scraping element, in particular the scraping element which is in the form of a rib, ring or ring segment, or resilient curved member is arranged in the front (axial) end region of the shank, that is to say, region facing away from the head. Preferably, the scraping element, in particular the scraping element which is in the form of a rib, ring or ring segment or resilient curved member, is arranged only in the front end region of the shank and extends, in particular starting from the front axial end of the shank, in an axial direction over only a part-length or axial part-portion of the shank. That is to say, the scraping element does not extend up to the head. (The same applies in a similar manner to a large number of scraping elements.) Such a configuration may be sufficient for the provided function of the scraping element.

There may be arranged on the sleeve at the lower side of the head a plurality of lower head ribs which in particular extend into the shank. The lower head ribs may then at the latest when the sleeve expands by pulling the tension mandrel push or press into the upper or head-side component, whereby in particular an improvement of the electrical contacting and where applicable also a rotation prevention are achieved. If ribs acting as scraping elements are provided, the lower head ribs may be arranged in an axial extension of these ribs and are in particular configured with a larger width than the ribs. The lower head ribs may also be arranged in a state offset between the ribs with respect to the circumferential direction.

The method according to the invention for producing an electrically conductive rivet connection between two components, whereby at least two components are intended to be understood, that is to say, at least a first component and at least a second component, comprises the following steps of:
arranging the components which are pre-perforated or pre-drilled, that is to say, which have already been provided with rivet holes or rivet openings, in such a manner that a substantially aligned rivet hole is produced.
positioning a breakstem blind rivet according to the invention by introducing or inserting the sleeve thereof into the rivet hole, wherein already during insertion the at least one scraping element scrapes along the hole wall and removes or scrapes away paint deposits, impurities or the like,
expanding the sleeve by pulling the tension mandrel, as known per se from the prior art, wherein the sleeve can bear on the scraped hole wall and a good, that is to say, low-resistance, electrically conductive contact between the sleeve and at least one of the components is produced.

Preferably, there is provision for the first component to be located at the top with respect to the introduction direction of the breakstem blind rivet and the second component to be located at the bottom. Furthermore, there is preferably provision for the at least one scraping element at least on the second lower component to remove or scrape away paint deposits, impurities or the like located in the rivet hole.

The components are joined in the manner explained above and connected in an electrically conductive manner, wherein the configuration of a very low electrical resistance can be ensured. It is thereby in particular intended to be understood that both between the first component and the breakstem blind rivet and between the second component and the breakstem blind rivet a low or low-resistance electrical resistance is formed, which results in a low or low-resistance overall transition resistance (for example, ≤5 milliohm).

The first component and the second component are preferably formed from metal and/or another electrically conductive material. At least one of the components, in particular the second component, may have a coat of paint or other contact-preventing or contact-impairing coating which was applied particularly after the perforation, that is to say, after the introduction of the rivet hole or opening, and can consequently at least partially protect the hole wall without requiring a pretreatment which precedes the riveting. Furthermore, the coating or painting operation is also simplified since the hole or the rivet opening does not have to be covered. Of course, more than two components can also be joined and connected in an electrically conductive manner in the manner mentioned above.

Preferably, the breakstem blind rivet or the shank thereof and/or mandrel head with respect to the rivet hole is configured with an overdimension which is caused by the at least one scraping element, whereby a diameter overdimension is particularly intended to be understood so that during introduction or insertion the above-described scraping effect is reliably brought about.

Both the introduction or insertion and the expansion can be carried out in an automated or partially automated manner, for example, using a conventional rivet gun, as described, for example, in DE 10 2011 012 112 A1. Such a rivet gun can be moved manually or by means of robots. Preferably, the breakstem blind rivet according to the invention is configured in such a manner that the pressing force required for introduction or insertion into the rivet hole does not exceed an introduction or pressing-in force (for example, from 40 to 60 N) which can be produced by the tool used (for example, rivet gun). The required introduction or pressing-in force can be adapted by configuring and arranging the at least one scraping element and where applicable also the number and distribution of a plurality of scraping elements. To this end, practical tests can also be carried out. The tensile force for expanding the sleeve is normally several kilonewton (kN). The at least one scraping element has no relevant influence on the expansion, in particular no unfavorable influence.

The first component is in particular an earth-contacting means which belongs to a vehicle component, in particular an electric vehicle component or which is electrically connected thereto, such as, for example, an earth cable or earth strap. Preferably, this earth-contacting means has a connection end which is intended to be connected by means of the breakstem blind rivet to the second component and which is in particular in the form of a cable lug, connection eyelet or the like. The second component is in particular a painted (vehicle) body component which is preferably formed from sheet metal or the like.

The breakstem blind rivet according to the invention is thus preferably used for the electrical earth connection or earth-contacting of a vehicle component, in particular of an electric vehicle component, a painted body component (of a vehicle body) which is preferably formed from sheet metal.

The invention will be explained below in a non-limiting manner with reference to the drawings. The features described and/or shown in the drawings may, depending on specific feature combinations, also be general features of the invention. Furthermore, the features of different possible embodiments may also be combined to form other possible embodiments.

### BRIEF DESCRIPTION OF THE DRAWINGS

FIG. 1 schematically shows a first possible embodiment of a breakstem blind rivet according to the invention before insertion into a rivet hole;

FIG. 2 schematically shows in a similar manner to FIG. 1 a second possible embodiment of a breakstem blind rivet according to the invention;

FIG. 3 schematically shows in a similar manner to FIG. 1 a third possible embodiment of a breakstem blind rivet according to the invention;

FIG. 4 schematically shows in a similar manner to FIG. 1 a fourth possible embodiment of a breakstem blind rivet according to the invention; and

FIG. 5 shows a fifth possible embodiment of a breakstem blind rivet according to the invention.

### DETAILED DESCRIPTION OF THE DRAWINGS

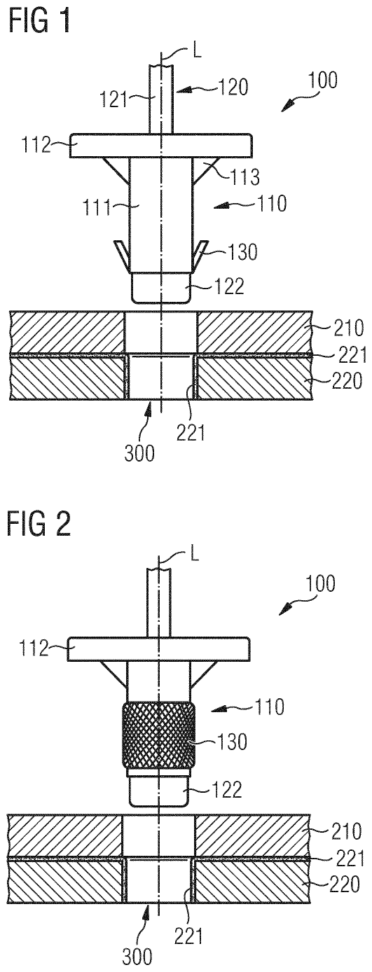

The breakstem blind rivet 100 shown in FIG. 1 has a sleeve 110 and a tension mandrel 120. The sleeve 110 and the tension mandrel 120 have a common longitudinal axis L. The sleeve 110 is configured with a shank 111 and a head 112. The shank 111 protrudes in an axial direction (that is to say, along the longitudinal axis L) from the head 112. The head 112 projects beyond the shank 111 in a lateral or radial direction and forms a rivet flange. The sleeve 110 is preferably formed in an integral manner from metal. The tension mandrel 120 is configured with a pin 121 which protrudes or extends in an axial direction through the sleeve 110, that is to say, the shank 111 and the head 112. The tension mandrel 120 is further configured with a mandrel head 122 which bears against the free shank end or the free end face of the shank 111. The tension mandrel 120 is also preferably formed in an integral manner from metal. The breakstem blind rivet 100 or the sleeve 110 thereof is further configured with lower head ribs 113. The breakstem blind rivet 100 is configured with respect to the longitudinal axis L substantially or at least approximately in a rotationally symmetrical manner.

FIG. 1 further shows two components, that is to say, a first (upper) component 210 and a second (lower) component 220. They are preferably metal components. The breakstem blind rivet 100 is provided to join the two components 210, 220 at the shown connection or joint location and to connect them in an electrically conductive manner. In other words, the breakstem blind rivet 100 is provided for an electrically conductive riveting of the two components 210, 220. The pre-perforated components 210, 220 are orientated with respect to each other so that there is produced an aligned rivet hole 300 in which the sleeve 110 of the breakstem blind rivet 100 is introduced or inserted and subsequently, by applying an axial tensile force to the tension mandrel (by pulling the pin 121), expanded in a manner known per se so that a positive-locking and permanent joint connection is formed (as shown, for example, in FIG. 5 of EP 3 111 097 B1).

The second (lower) component 220 has a paint coating 221 which prevents or at least impairs direct electrical contact and which also at least partially protects or covers the hole wall. The paint coating 221 may, also on the hole wall, have a thickness of several tenths of a millimeter. The breakstem blind rivet 100 is provided according to the invention with at least one scraping element 130 which, when the sleeve 110 or the shank 111 is introduced or inserted into the rivet hole 300, scrapes along the hole wall or inner hole circumferential face and at least partially removes or scrapes off any paint deposits, impurities or the like in the rivet hole 300, that is to say, both on the first component 210 and on the second component 220, and also the paint coating 221 on the second (lower) component 220. Consequently, without further pretreatment of the components 210, 220, in particular without pretreatment of the lower painted component 220, an electrically conductive rivet connection or riveting with a low overall transition resistance can be produced, wherein the electrically conductive connection or the power flow between the components 210, 220 is produced substantially via the set or joined breakstem blind rivet 100. With a breakstem blind rivet 100 configured according to the invention, more than two components can also be riveted in an electrically conductive manner.

In the possible embodiment of the breakstem blind rivet 100 as shown in FIG. 1, there is provided at least one scraping element 130 which is arranged on the outer circumferential face or lateral covering face of the shank 111 and which is in the form of a resilient curved member or spring clip. Such a resilient curved member which is arranged in this instance in the front end region of the shank 111 and which protrudes from the front axial end of the shank 111 laterally in the direction of the head 112 is provided to scrape along the hole wall when the sleeve 110 is introduced into the rivet hole 300 and where applicable to become deformed in the direction of the shank 111 and to bear on the shank 111. The scraping element 130 or the resilient curved member may be in the form of a circumferential plate-spring-like ring element or annular curved member, wherein a plurality of axially spaced plate-spring-like ring elements or annular curved members may also be provided. The scraping element 130 or the resilient curved member may also be in the form of an only partially circumferential annular curved member segment or a strip element, wherein preferably a plurality of (that is to say, at least two) annular curved member segments and/or strip elements which are arranged in a circumferential direction and/or in an axial direction in a state distributed on the outer circumferential face of the shank 111 are provided. The outer face of such a scraping element 130 which is in the form of a resilient curved member may have a nature which promotes the scraping effect, for example, a sharp-edged or rough surface structuring.

In the possible embodiment of the breakstem blind rivet 100 as shown in FIG. 2, there is also provided (at least) one scraping element 130 which is arranged on the outer circumferential face of the shank 111 but which in this instance is in the form of a ring which extends in the circumferential direction. The outer face of the ring which acts as a scraping element may have a nature which promotes the scraping effect, in particular a sharp-edged or rough surface structuring. Such a surface structuring is, for example, a rasp-like surface structure (as illustrated by the crossed lines). In an axial direction, the ring may also be configured to be relatively narrow, virtually in the form of a bead. In place of a single circumferential ring, an only partially circumferential ring segment or a plurality (that is to say, at least two) ring segments which are arranged in a state distributed in the circumferential direction and/or axial direction on the outer circumferential face of the shank 111 may also be provided. Furthermore, a plurality of rings which are axially spaced apart from each other may also be provided.

In the possible embodiments shown in FIG. 1 and FIG. 2, there may be provision for the at least one scraping element 130 to be arranged on the shank 111 of the sleeve 110 in such a manner that, after the introduction or insertion, it is still at least partially located inside the rivet hole 300. During subsequent expansion of the sleeve 111 (by applying an axial pressing force to the pin 121 of the tension mandrel 120), the scraping element 130 can then be pressed into the hole wall or inner hole circumferential face and break up or break through any remaining paint deposits, impurities or the like so that, on the one hand, a particularly secure mechanical connection and, on the other hand, a particularly good electrically conductive connection are formed.

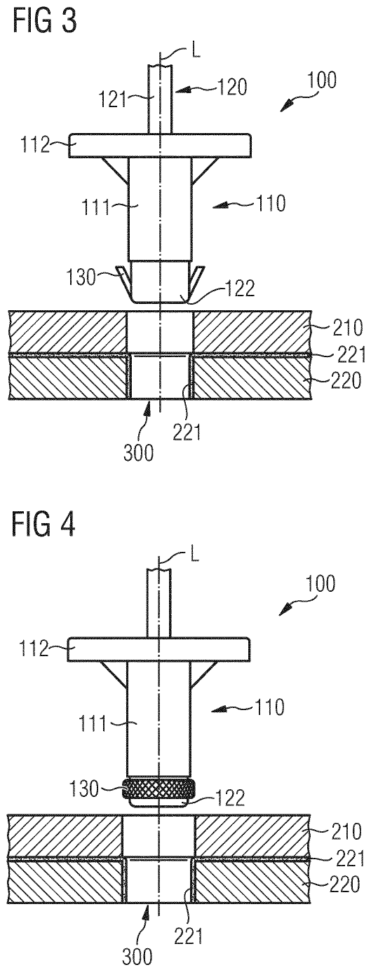

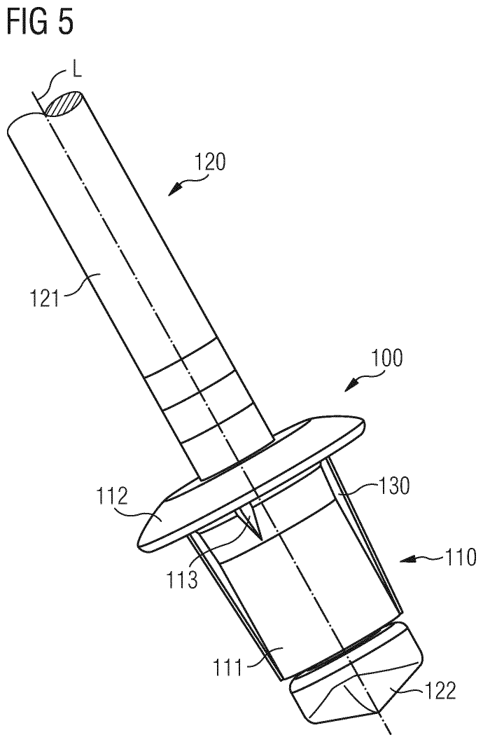

The possible embodiments of the breakstem blind rivet 100 as shown in FIG. 3 and FIG. 4 differ from the possible embodiments shown in FIG. 1 and FIG. 2 in that the at least one scraping element 130 which is in the form of a resilient curved member or a ring or ring segment is not arranged on the shank 111 of the sleeve 110, but instead on the outer circumferential face of the mandrel head 122 of the tension mandrel 120. Otherwise, the explanations relating to the possible embodiments shown in FIG. 1 and FIG. 2 apply similarly

In the possible embodiments shown in FIG. 3 and FIG. 4, there may be provision for the at least one scraping element 130 which is arranged on the mandrel head 122 also to be provided and configured accordingly such that, when the sleeve 111 is compressed or expanded, it virtually presses from below into the second (lower) component 220 so that a particularly secure mechanical connection and also a particularly good electrically conductive connection are formed.

In the possible embodiment of the breakstem blind rivet 100 as shown in FIG. 5, a plurality of scraping elements 130 which are formed as radially protruding ribs on the outer circumferential face of the shank 111 are provided. The ribs extend linearly in an axial direction and are conically formed. Other variants are described above. The ribs may have a comparatively small rib width in the circumferential direction, that is to say, be configured to be relatively thin (almost blade-like) so that, when the sleeve 110 is introduced or inserted into a rivet hole, a combined cutting and scraping effect can occur. In contrast to the possible embodiments shown in FIG. 1 and FIG. 2, in which the at least one scraping element 130 is formed in the axial direction only over a part-length of the shank 111, the scraping elements 130 which are in this instance in the form of ribs extend over the entire axial length of the shank 111, that is to say, from the front axial end of the shank 111 up to the lower side of the head 112. The lower head ribs 113 are in this instance arranged in a state offset in the circumferential direction between the scraping elements 130 which are in the form of ribs.

### LIST OF REFERENCE NUMERALS

100 Breakstem blind rivet
110 Sleeve
111 Shank
112 Head
113 Lower head rib
120 Tension mandrel
121 Pin
122 Mandrel head
130 Scraping element
210 First component
220 Second component
221 Paint coating
300 Rivet hole
L Longitudinal axis

1.-9. (canceled)

10. A breakstem blind rivet for electrically conductive riveting of a first component to a second component, comprising:
a sleeve which is configured with a head and a shank, and
a tension mandrel which is configured with a mandrel head, wherein
the shank and/or the mandrel head has/have at least one scraping element which is arranged on an outer circumferential face thereof and which is provided, when the sleeve is introduced into a rivet hole provided for this purpose, to scrape along the hole wall and to remove paint deposits and/or impurities.

11. The breakstem blind rivet according to claim 10, wherein the scraping element is a radially protruding rib.

12. The breakstem blind rivet according to claim 10, wherein the scraping element is a circumferential ring.

13. The breakstem blind rivet according to claim 10, wherein the scraping element is a resilient curved member.

14. The breakstem blind rivet according to claim 10, wherein
the scraping element, which is in a form of a rib, a ring or a resilient curved member, is arranged in a front end region of the shank and extends in an axial direction over only a part-length of the shank.

15. The breakstem blind rivet according to claim 10, wherein
a plurality of lower head ribs, which extend into the shank, are arranged in a lower side of the head.

16. A method for producing an electrically conductive rivet connection between a first component and a second component, the method comprising the steps of:
arranging pre-perforated first and second components such that an aligned rivet hole is produced;
positioning a breakstem blind rivet into the rivet hole, wherein the breakstem blind rivet comprises a sleeve which is configured with a head and a shank, a tension mandrel which is configured with a mandrel head, wherein the shank and/or the mandrel head has/have at least one scraping element which is arranged on an outer circumferential face thereof, wherein the at least one scraping element scrapes along the hole wall and removes paint deposits or impurities during the positioning; and
expanding the sleeve by pulling the tension mandrel.

17. The method according to claim 16, wherein the first component is a ground-contacting component which belongs to an electric vehicle component and the second component is a painted body component.

18. A method for producing an electrically connecting rivet connection between a first and a second component utilizing the breakstem blind rivet according to claim 10.
